(19) United States
(12) Patent Application Publication
(10) Pub. No.: US 2011/0154485 A1
(43) Pub. Date: Jun. 23, 2011

(54) AUTHENTICATION APPARATUS USING HUMAN BODY COMMUNICATION, PORTABLE DEVICE HAVING AUTHENTICATION FUNCTION USING HUMAN BODY COMMUNICATION, AND AUTHENTICATION METHOD USING HUMAN BODY COMMUNICATION

(75) Inventors: Seok Bong HYUN, Daejeon (KR); Sung Weon Kang, Daejeon (KR); Jung Hwan Hwang, Daejeon (KR); Tae Young Kang, Daejeon (KR); Tae Wook Kang, Daejeon (KR); Kyung Soo Kim, Daejeon (KR); Sung Eun Kim, Seoul (KR); Jung Bum Kim, Daejeon (KR); Kyung Hwan Park, Daejeon (KR); Hyung Park, II, Daejeon (KR); In Gi Lim, Daejeon (KR); Byoung Gun Choi, Daegu (KR); Chang Hee Hyoung, Daejeon (KR)

(73) Assignee: Electronics and Telecommunications Research Institute, Daejeon (KR)

(21) Appl. No.: 12/974,709

(22) Filed: Dec. 21, 2010

(30) Foreign Application Priority Data
Dec. 22, 2009 (KR) 10-2009-0129265
Jun. 3, 2010 (KR) 10-2010-0052444

(51) Int. Cl. H04L 9/32

(52) U.S. Cl. 726/19

(57) ABSTRACT

Disclosed are an authentication apparatus using human body communication capable of improving the security and convenience of user authentication by using human body communication, a portable device having authentication function using human body communication, and an authentication method using human body communication. In the authentication method using human body communication, an authentication device acquires user biometric information and provides the acquired biometric information to a portable device by using human body communication. The portable device then compares the acquired biometric information with previously stored biometric information, and when the acquired biometric information and the previously stored biometric information are identical, the portable provides authentication information to the authentication device. Upon receiving the authentication information, the authentication device performs an authentication procedure based on the authentication information. Thus, security and user convenience can be improved, and an authentication can be quickly performed.

### CROSS-REFERENCE TO RELATED APPLICATIONS

This application claims the priority of Korean Patent Application Nos. 10-2009-0129265 filed on Dec. 22, 2009, and 10-2010-0052444 filed on Jun. 3, 2010, in the Korean Intellectual Property Office, the disclosure of which is incorporated herein by reference.

### BACKGROUND OF THE INVENTION

1. Field of the Invention

The present invention relates to user authentication and, more particularly, to an authentication apparatus using human body communication capable of improving the security and convenience of user authentication by using human body communication, a portable device having an authentication function using human body communication, and an authentication method using human body communication.

2. Description of the Related Art

Human body communication is a communication scheme in which current flows directly to devices attached to a human body or an electric field is formed therebetween by using the human body as a transmission medium to thus allow for a data transmission and reception therebetween. Because human body communication uses baseband signals of 30 MHz or lower, without using carriers, and secures a data transfer rate of hundreds of kbps to scores of Mbps according to modulation schemes, it is utilized for high speed radio communications, and various applications using human body communication are being generated.

For example, recently, devices for authenticating users or the use of credit cards using a human body as a medium have bee actively developed.

U.S. Pat. No. 5,796,827 (Title: System and Method for Near-Field Human-Body Coupling for Encrypted Communication with Identification Cards) discloses a technique of improving the transmission security of credit card data by using a human body as a medium.

FIG.1 illustrates the related art data transmission technique using human body communication.

With reference to FIG. 1, in the related art data transmission technique using human body communication (U.S. Pat. No. 5,796,827), when the hand or a portion of a user 2 who holds a card 1, including card information, comes into contact with an electrode 4 disposed on a front surface of a card reader 3, data communication is performed between the carder reader 3 and the card 1 held by the user and the card information included in the card 1 is transmitted to the card reader 3. Here, the card 1 encrypts the transmission data by using an ID of the user and then transmits the data through human body communication, and the card reader 3 decrypts the received data and authenticates it.

However, the related art data transmission technique using human body communication illustrated in FIG. 1 discloses only the technique of transmitting and receiving encrypted data by using human body communication, without measures for fundamentally preventing the card from being used fraudulently in the case that the card is lost, stolen, or copied.

Also, Korean Laid Open Publication No. 2008-40859 (Title: User Authentication System Using Human Body Communication) discloses a technique of authenticating a user by transmitting and receiving user information by using human body communication.

FIG. 2 is a schematic block diagram of the related art user authentication system using human body communication.

With reference to FIG. 2, in the related art user authentication system using human body communication (Korean Laid Open Publication No. 2008-40859), a first human body communication device 10 requests system information desired to be authenticated from a second human body communication device 20 by the medium of a human body 30, and the second human body communication device 20 transmits system identification information (i.e., system ID) in response to the request. Thereafter, the second human body communication device 20 searches a storage device 23 for user authentication information (a user ID, a password, etc.) set for a corresponding system and transfers searched user authentication information to the first human body communication device 10 by the medium of the human body 30. Upon receiving the user authentication information, the first human body communication device 10 compares the user authentication information with authentication information stored in a system authentication DB 40. When the respective units of authentication information match, access to the system is granted.

However, the related art user authentication system using human body communication as illustrated in FIG. 2 requires that the user authentication information for authenticating a user be stored in the system authentication DB 40 in advance. That is, the related art system requires a process of previously storing the user authentication information, so an exposure of system authentication DB 40 to an external intimidation such that it could be used fraudulently, copied, or changed, would cause tremendous damage, and thus, the related art system is not suitable for financial transactions requiring a high level of security.

In addition, the related art method of recognizing a user through fingerprint recognition has a problem in that the fingerprint information of every user who needs to be authenticated must be previously stored in an authentication server connected to a reader devised for recognizing fingerprints, resulting in the necessity of a large storage space, and the reader needs to have a processing capability for recognizing and comparing fingerprints at high speed. Thus, the establishment of such a system for recognizing the fingerprints of numerous users incurs a huge amount of costs, and as the number of users increases, the time required for searching for a fingerprint is inevitably increased to lengthen a waiting time, degrading user convenience.

### SUMMARY OF THE INVENTION

An aspect of the present invention provides an authentication device using human body communication capable of improving security and user convenience.

Another aspect of the present invention provides a portable device having an authentication function using human body communication.

Another aspect of the present invention provides an authentication method using human body communication capable of improving security and user convenience.

According to an aspect of the present invention, there is provided an authentication device including: a biometric information detection unit detecting user biometric information; a first controller providing control to provide the detected biometric information to a portable device and performing an authentication procedure based on authentication information provided by the portable device; and a first human body communication unit transmitting the biometric information to the user's body under the control of the first controller, receiving the authentication information through the user's body, and providing the received authentication information to the first controller.

The authentication device may further include: a communication unit transmitting the biometric information to a predetermined destination under the control of the first controller.

When information indicating that authentication is not possible is provided by the portable device, the first controller may transmit the biometric information to the predetermined destination through the communication unit.

The first controller may extract a distinctive feature from the biometric information and transmit the distinctive feature of the biometric information to the portable device through the first human body communication unit.

The authentication information may include at least one of a user's personal information and financial transaction-related information.

According to another aspect of the present invention, there is provided a portable device communicating with an authentication device by using human body communication, including: a second human body communication unit receiving first biometric information transmitted from the authentication device through a user's body and transmitting authentication information to the user's body; a second controller providing the authentication information to the second human body communication unit when the first biometric information and previously stored second biometric information are identical; and a storage unit storing the second biometric information and the authentication information.

When the second controller determines that the first biometric information and the second biometric information are not identical, it may provide information indicating that authentication is not possible to the authentication device through the second human body communication unit.

The authentication information may include at least one of a user's personal information and financial transaction-related information, and when the first biometric information and previously stored second biometric information are identical, the second controller may provide only one of the personal information and financial transaction-related information of the user to the second human body communication unit.

The personal information of the user may include at least one of a user's name, a social secret number (e.g., a social security number), an ID, a password, an address, and a digital signature, and the financial transaction-related information may include at least one of a credit card number, an account number, and a digital certificate number.

According to another aspect of the present invention, there is provided an authentication method using human body communication, including: acquiring, by an authentication device, user biometric information; providing, by an authentication device, the acquired biometric information to a portable device through human body communication; comparing, by the portable device, the acquired biometric information with previously stored biometric information; when the acquired biometric information and the previously stored biometric information are identical, providing, by the portable device, authentication information to the authentication device; and performing, by the authentication device, an authentication procedure based on the provided authentication information.

The providing of the acquired biometric information to the portable device through human body communication by the authentication device may include: extracting, by the authentication device, a distinctive feature of the acquired biometric information; and providing the extracted distinctive feature of the biometric information to the authentication device.

The method may further include: providing, by the portable device, information indicating that authentication is not possible to the authentication device when the acquired biometric information and the previously stored biometric information are not identical; and receiving, by the authentication device, the information indicating that authentication is not possible, and transmitting the acquired biometric information to a pre-set destination.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is the related art data transmission technique using human body communication;

FIG. 2 is a schematic block diagram of the related art user authentication system using human body communication;

FIG. 3 is a conceptual view for explaining an authentication system using human body communication according to an exemplary embodiment of the present invention;

FIG. 4 is a schematic block diagram showing a detailed structure of an authentication device illustrated in FIG. 3;

FIG. 5 is a schematic block diagram showing the structure of a portable device according to an exemplary embodiment of the present invention; and

FIG. 6 is a flow chart illustrating the process of an authentication method using human body communication according to an exemplary embodiment of the present invention.

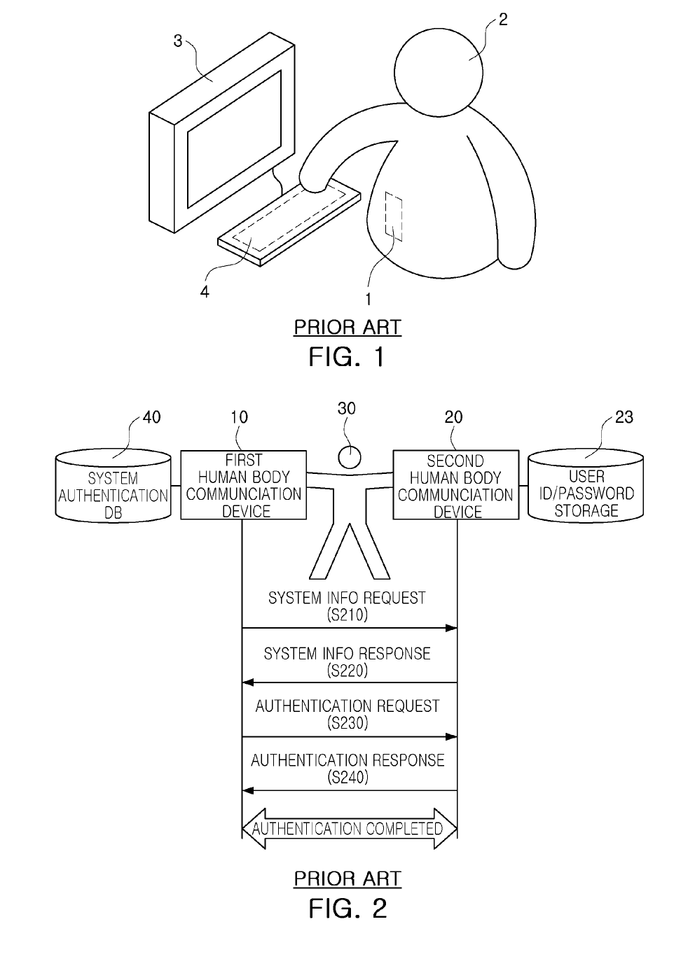

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

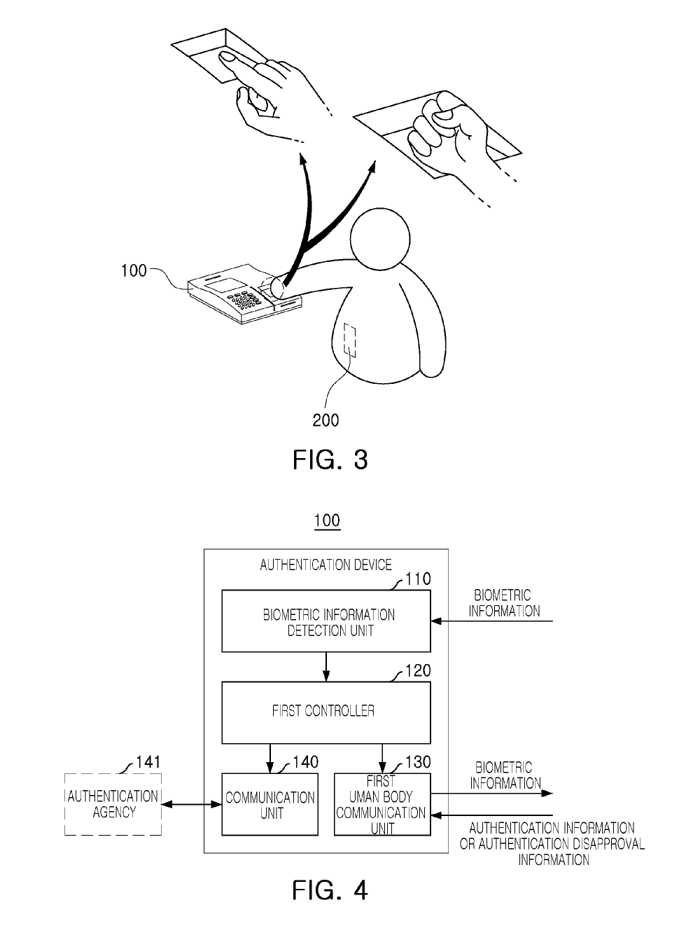

FIG. 3 is a conceptual view for explaining an authentication system using human body communication according to an exemplary embodiment of the present invention.

With reference to FIG. 3, an authentication system using human body communication may include an authentication device using human body communication (referred to as an ‘authentication device’, hereinafter) 100 and a portable device having an authentication function (referred to as a ‘portable device’, hereinafter) 200.

First, the authentication device 100 receives biometric information such as a user's fingerprint, the shape of the user's palm, the pattern of the user's veins, and the like, from the user and provides the received biometric information to the portable device 200 through human body communication.

The portable device 200 compares the biometric information provided by the authentication device 100 with previously stored biometric information. When the provided biometric information is identical to the previously stored biometric information, the portable device 200 provides authentication information to the authentication device 100 to allow the authentication device 100 to perform authentication. If, however, the provided biometric information is not identical to the previously stored biometric information, the portable device 200 provides authentication disapproval information to the authentication device 100.

When the authentication device 100 receives the authentication information from the portable device 200, the authentication device 100 performs an authentication procedure by using the received authentication information. Meanwhile, when the authentication device 100 receives the authentication disapproval information, the authentication device 100 may display an authentication disapproval message or transmit acquired biometric information to an authentication agency (or an authentication organization) or a predetermined authentication-relevant agency.

In FIG. 3, the authentication device 100 may be installed in all equipment or every machine, such as a credit card reader, an automatic teller machine (ATM), a vending machine, and the like, which performs authentication by using user biometric information, and the portable device 200 may be implemented as a device, such as a mobile phone, a watch, a credit card, a belt, and the like, to be carried around by users or attached to the users.

FIG. 4 is a schematic block diagram showing a detailed structure of an authentication device illustrated in FIG. 3.

With reference to FIG. 4, the authentication device 100 may include a biometric information detection unit 110, a first controller 120, a first human body communication unit 130, and a communication unit 140.

The biometric information detection unit 110 may be configured as, for example, a scanner which is able to scan biometric information such as a user's fingerprint, the shape of the user's palm, the pattern of the user's veins, and the like. When the biometric information detection unit 110 acquires the user biometric information, it provides the acquired user biometric information to the first controller 120.

The first controller 120 processes the biometric information provided by the biometric information detection unit 110, extracts a distinctive feature of the biometric information, and provides biometric information including only the extracted distinctive feature to the portable device 200 through the first human body communication unit 130. Here, the first controller 120 may provide the biometric information provided by the biometric information detection unit 110 as it is to the portable device 200, without processing the received biometric information, but only the distinctive feature of the biometric information may be transmitted in order to enhance transfer efficiency in the data transmitted and received through human body communication.

In addition, the first controller 120 performs authentication based on the user authentication information or authentication disapproval information provided by the portable device 200 through the first human body communication unit 130. Here, when the authentication information is provided, the first controller 120 may directly perform authentication by using the provided authentication information or may transmit an authentication request message and the authentication information to an authentication agency 141 such as a credit card company, a bank, or the like, through the communication unit 140.

Meanwhile, when the authentication disapproval information is provided, the first controller 120 may display the received authentication disapproval information through a display device (not shown) or transmit the user biometric information and/or authentication disapproval information to the authentication agency or a predetermined relevant agency through the communication unit 140.

The first human body communication unit 130 receives the biometric information from the first controller 120, processes the received biometric information such that it fits a human body communication standard, and transmits the processed biometric information to the user's body, or the first human body communication unit 130 receives authentication information or authentication disapproval information transmitted through the user's body, processes the received information, and provides the processed information to the first controller 120.

The communication unit 140 may be configured as a wired communication interface or a wireless communication interface. The communication unit 140 converts the authentication information or the authentication request message provided by the first controller such that it fits a communication standard, transmits the converted authentication message and the authentication request message to the authentication agency or a pre-set destination, and provides an authentication result transmitted from the authentication agency to the first controller 120. Here, when the first controller 120 directly performs authentication, the communication unit 140 may not be included in the authentication device 100.

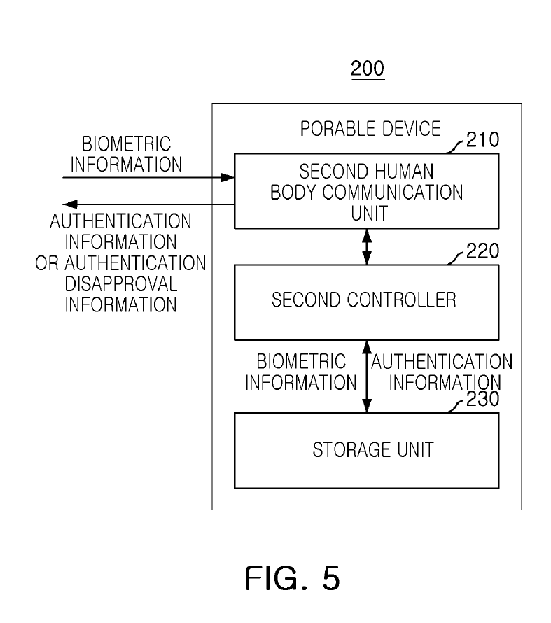

FIG. 5 is a schematic block diagram showing the structure of the portable device according to an exemplary embodiment of the present invention.

With reference to FIG. 5, the portable device 200 according to an exemplary embodiment of the present invention may include a second human body communication unit 210, a second controller 220, and a storage unit 230.

The second human body communication 210 receives user biometric information provided by the authentication device 100 through the user's body, processes, for example, by demodulating, the received biometric information, and provides the processed biometric information to the second controller 220.

In addition, the second human body communication unit 210 processes the authentication information provided by the second controller 220 such that it fits human body communication, and then transmits the processed authentication information to the user's body.

The second controller 220 receives the biometric information from the second human body communication unit 210, reads biometric information stored in the storage unit 230, and compares the provided biometric information and the read biometric information in order to determine whether or not the respective units of biometric information are identical.

When the second controller 220 determines that the respective units of biometric information are identical, the second controller 220 reads authentication information from the storage unit 230 and provides the read authentication information to the second human body communication unit 210, thus providing the authentication information to the authentication device 100. If the second controller 220 determines that the respective units of biometric information are not identical, the second controller 220 provides authentication disapproval information to the second human body communication unit 210, thus not allowing the performing of authentication.

The storage unit 230 stores the biometric information and the authentication information. Here, the authentication information may include the user's personal information, such as the user's name, social secret number, ID, password, address, and digital signature, and the like, or financial transaction-related information such as a credit card number, an account number, a digital certificate number, and the like.

The portable device 200 having the authentication function using human body communication illustrated in FIG. 5 can be implemented in various forms.

For example, the portable device 200 may be implemented in the form of a wristwatch or a belt which is possibly always worn by the user, and the user authentication information (e.g., personal information, credit card information, and the like.) and the biometric information (e.g., a fingerprint) may be stored in the storage unit 230 of the portable device 200.

Alternatively, the portable device 200 may be implemented to be installed within a mobile communication terminal such as a mobile phone, a personal digital assistant (PDA), and the like. In this case, a processor of the mobile communication terminal may perform the function of the second controller 220 of the portable device 200 and a non-volatile memory included in the mobile communication terminal may be shared by the storage unit 230 so as to be used. When the portable device 200 is installed in the mobile communication terminal and credit card information and fingerprint information are stored in the storage unit 230, the user of the mobile communication terminal can perform a credit card payment by simply touching (or placing) a finger to a credit card reader (e.g., the authentication device illustrated in FIG. 4) having the human body communication and fingerprint recognition function, without having to take out his credit card to use it.

Alternatively, the portable device 200 may be fabricated in the form of a small chip so as to be installed in a credit card. Namely, the portable device 200 may be fabricated in the form of a credit card, and the storage unit 230 may store credit card information and user fingerprint information. Also, in this case, the user can authenticate his credit card to use it by simply touching a finger to the card reader.

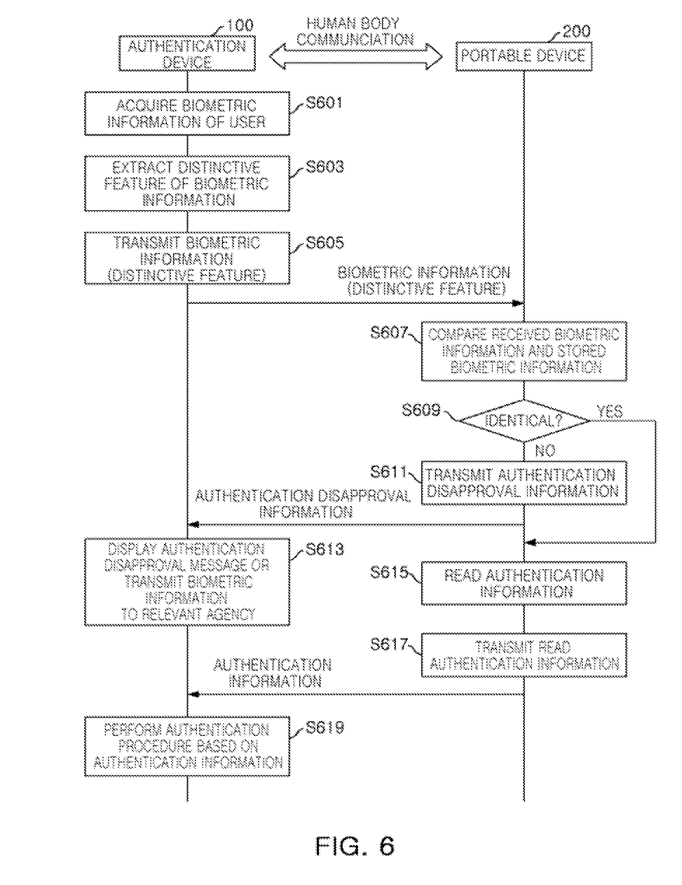

FIG. 6 is a flow chart illustrating the process of an authentication method using human body communication according to an exemplary embodiment of the present invention.

With reference to FIG. 6, the authentication device 100 acquires biometric information from the user (S601). Here, the authentication device 100 may acquire biometric information such as the user's fingerprint, the shape of his palm, his vein, and the like, and signal-processes the acquired biometric information to extract a distinctive feature of the biometric information (S603).

Thereafter, the authentication device 100 transmits the acquired biometric information (or the distinctive feature of the biometric information) to the portable device 200 through human body communication (S605).

Upon receiving the biometric information from the authentication device 100, the portable device 200 compares the received biometric information with previously stored biometric information (S607) to determine whether or not the respective units of biometric information are identical (S609).

When the portable device determines that the respective units of biometric information are not identical, the portable device transmits authentication disapproval information to the authentication device 100 (S611). Then, the authentication device 100 displays an authentication disapproval message corresponding to the authentication disapproval information transmitted from the portable device 200 or transmits the biometric information and/or the authentication disapproval information to the authentication agency or the authentication-relevant agency (S613).

Meanwhile, when the portable device 200 determines that the respective units of biometric information are identical in step S609, the portable device 200 reads the previously stored authentication information (S615) and transmits the read authentication information to the authentication device 100 through human body communication (S617).

Upon receiving the authentication information from the portable device 200, the authentication device 100 performs an authentication procedure based on the received authentication information (S619). Here, the authentication procedure using the authentication information can be performed by applying a known authentication method, so a detailed description thereof will be omitted.

In the authentication method using human body communication illustrated in FIG. 6, when financial transaction-related authentication and biometric recognition are separately yet simultaneously performed, user's personal information may be transmitted as authentication information. For example, when the user directly touches his credit card to the credit card reader, i.e., an authentication device, and simultaneously inputs his fingerprint, the authentication information transmitted to the authentication device 100 in step S617 may include only the user's personal information, and the authentication device 100 can perform an authentication procedure by using the credit card information acquired from the credit card reader and the user's personal information transmitted from the portable device 200 through human body communication.

As set forth above, in the authentication apparatus using human body communication, the portable device having authentication function using human body communication, and the authentication method using human body communication, the authentication device provides user biometric information to a portable device of the user by using human body communication, and the portable device compares the biometric information provided by the authentication device and stored biometric information. Only when the respective units of biometric information are identical, the portable device provides authentication device through human body communication.

Thus, because the user only needs to provide biometric information such as his fingerprint, the shape of his palm, patterns of his veins, and the like, for his authentication, user convenience can be improved.

For example, the related art method for authenticating a credit card through a signature cannot accurately identify a credit card user substantially because of a high possibility that the credit card can be easily forged, but in the present invention, biometric information of the user transmitted by using human body communication is compared and authentication is performed according to the comparison result, so forgery or behavior of using by stealth by an unauthorized user can be fundamentally prevented, and because authentication is performed by using biometric information, damage in the occurrence of a burglary or loss of a credit card can be minimized.

In addition, because the portable device carried around by the user determines whether or not the user is authenticated by simply comparing only the biometric information of the user himself, the user can be quickly and accurately authenticated.

Moreover, the user can be double-authenticated by using both financial transaction information such as credit card information and personal information of the user, finance or banking-related crimes can be prevented.

While the present invention has been shown and described in connection with the exemplary embodiments, it will be apparent to those skilled in the art that modifications and variations can be made without departing from the spirit and scope of the invention as defined by the appended claims.

What is claimed is:

1. An authentication device comprising:
a biometric information detection unit detecting user biometric information;
a first controller providing control to provide the detected biometric information to a portable device and performing an authentication procedure based on authentication information provided by the portable device; and
a first human body communication unit transmitting the biometric information to the user's body under the control of the first controller, receiving the authentication information through the user's body, and providing the received authentication information to the first controller.

2. The device of claim 1, wherein the authentication device further comprises a communication unit transmitting the biometric information to a predetermined destination under the control of the first controller.

3. The device of claim 2, wherein when information indicating that authentication is not possible is provided by the portable device, the first controller transmits the biometric information to the predetermined destination through the communication unit.

4. The device of claim 1, the first controller extracts a distinctive feature from the biometric information and transmits the distinctive feature of the biometric information to the portable device through the first human body communication unit.

5. The device of claim 1, wherein the authentication information comprises at least one of a user's personal information and financial transaction-related information.

6. A portable device communicating with an authentication device by using human body communication, the device comprising:
a second human body communication unit receiving first biometric information transmitted from the authentication device through a user's body and transmitting authentication information to the user's body;
a second controller providing the authentication information to the second human body communication unit when the first biometric information and previously stored second biometric information are identical; and
a storage unit storing the second biometric information and the authentication information.

7. The device of claim 6, wherein when the second controller determines that the first biometric information and the second biometric information are not identical, the second controller provides information indicating that authentication is not possible to the authentication device through the second human body communication unit.

8. The device of claim 6, wherein the authentication information comprises at least one of a user's personal information and financial transaction-related information, and when the first biometric information and previously stored second biometric information are identical, the second controller provides only one of the personal information and financial transaction-related information of the user to the second human body communication unit.

9. The device of claim 8, wherein the personal information of the user comprises at least one of a user's name, social secret number, ID, password, address, and digital signature, and the financial transaction-related information comprises at least one of a credit card number, an account number, and a digital certificate number.

10. An authentication method using human body communication, the method comprising:
acquiring, by an authentication device, user biometric information;
providing, by an authentication device, the acquired biometric information to a portable device through human body communication;
comparing, by the portable device, the acquired biometric information with previously stored biometric information;
when the acquired biometric information and the previously stored biometric information are identical, providing, by the portable device, authentication information to the authentication device; and
performing, by the authentication device, an authentication procedure based on the provided authentication information.

11. The method of claim 10, wherein the providing of the acquired biometric information to the portable device through human body communication by the authentication device comprises:
extracting, by the authentication device, a distinctive feature of the acquired biometric information; and
providing the extracted distinctive feature of the biometric information to the authentication device.

12. The method of claim 10, further comprising:
providing, by the portable device, information indicating that authentication is not possible to the authentication device when the acquired biometric information and the previously stored biometric information are not identical; and
receiving, by the authentication device, the information indicating that authentication is not possible, and transmitting the acquired biometric information to a pre-set destination.
